(19) United States
(12) Patent Application Publication
(10) Pub. No.: US 2009/0236234 A1
(43) Pub. Date: Sep. 24, 2009

(54) Electrolytic Process for Managing Urban Sewage

(76) Inventor: Markos Ninolakis, Chania (GR)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/226,070

(22) PCT Filed: Mar. 26, 2007
(86) PCT No.: PCT/GR2007/000021

§ 371 Date: Apr. 21, 2009

(30) Foreign Application Priority Data
Apr. 7, 2006 (GR) 20060100215

(51) Int. Cl. C02F 1/461; C02F 1/40

(52) U.S. Cl. 205/743; 205/752

(57) ABSTRACT

An electrolytic process for managing urban sewage wherein sewage, before entering the treatment unit, is mixed with oxidants produced in an electrolytic mode and the mixture enters the treatment unit wherein, while containing oxidants, it passes successively through a) a sand sedimentation tank, b) fine self-cleansed grids, c) a DAFF system for defatting, d) a number of filters, finally coming to an oxidation tank wherein on the basis of the readings of a REDOX meter and a pH-meter is performed, if necessary, a further oxidation on a PLC command. The sewage under treatment passes subsequently through an electrode of high hydroxyl root production is reduced when getting out of the electrode and finally passes through an activated carbon filter. The gridates and filtrates are forwarded to a continuous electrolysis tank till oxidized to the degree provided by the legislation in force.

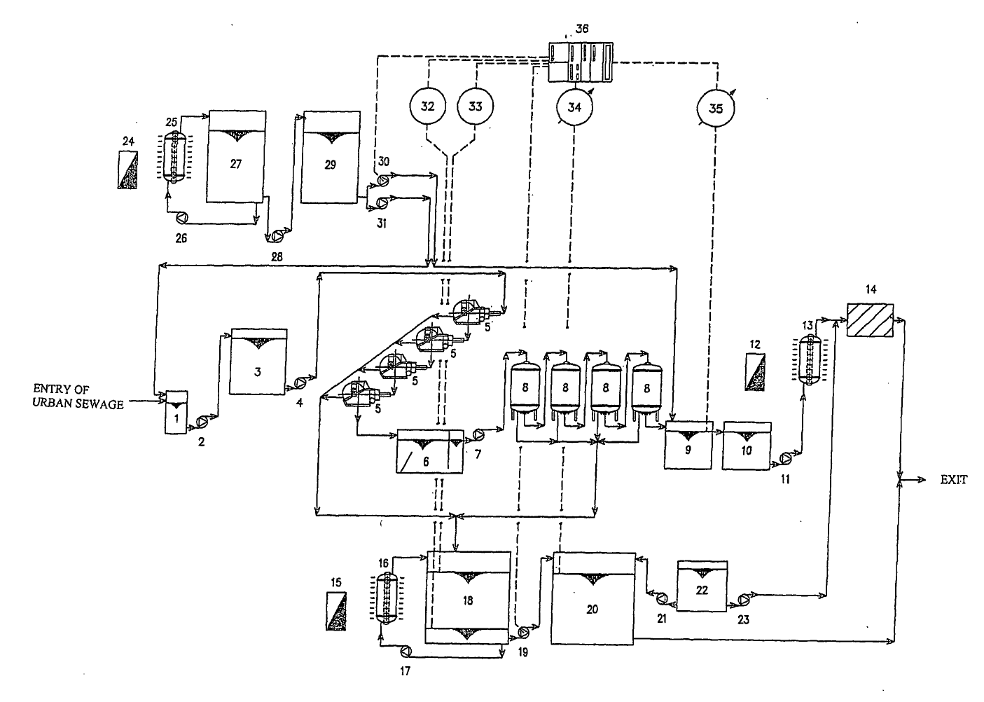

### TECHNICAL FIELD

This invention relates to an electrolytic process for managing urban sewage.

### STATE OF THE ART

Urban sewage management is mainly performed so far by biological processes through development of proper microorganisms. Biological method with its all variants follows a concrete sewage flow and creates sewage sludge which is a great environmental problem. Furthermore, the biological method for urban sewage management is a process susceptible to climate changes and fails to apply at altitudes above 1000 m. Its response to differentiations of hydraulic-organic charge of sewage, because of its large period of adjustment is insufficient. Its reliability as to the effluent result is not so high and emission of odours is a usual phenomenon in the biological treatment of urban sewage, during the decontamination thereof organic chlorine compounds being usually produced.

### ADVANTAGES OF THE INVENTION

Electrolytic management of urban sewage with regard to its biological treatment is always a reliable process, is not affected by external factors as climate conditions and altitude, is adjusted immediately to variations of hydraulic charge of sewage flow, as well as to the increase of its organic charge, is economically advantageous and can be applied in the already existing works of biological treatment. The process can transform sewage, by the method of liquid oxidation of organic substances included in the urban sewage, to sterile water, lacking odours and within the limits stipulated by legislation for discharging, without creating sewage sludge, managing of the latter being one of the greatest environmental problems of the planet. Furthermore, from the hydrogen released during electrolysis, electric power can be produced by means of fuel cells. Due to being able to producing simultaneously ozone, atomic oxygen, hydrogen peroxide, chlorine oxide along with nascent chlorine, production of organic chlorine compounds is prevented.

### DESCRIPTION OF THE PROCESS

An aqueous solution of sodium chloride, conc. 0.5% to 10%, is carried into a tank intended for oxidant production. The solution reflows in the oxidant producing tank through an electrode by means of a pump. The electrode is supported by an electronically regulated DC power supply, volt. 5-60V, int. up to 1000 A. The NaCl solution is electrolyzed till receiving a concentration of 1000 mg-9000 mg of oxidants per litre, expressed as free chlorine. The oxidants are forwarded to the urban sewage pump station by means of a dosage pump and are mixed with the urban sewage at a concentration of 5 mg/l to 200 mg/l. The sewage/oxidants solution is forwarded from the pump station by means of a litter pump to the sand sedimentation/equilibration tank and then passes through four successive self-cleansed grids with openings of 1.5 mm to 0.25 mm coming to a type DAFF defatting device. After coming out of DAFF, sewage passes through four self-cleansed filters with 150 μm to 5 μm meshes, respectively. The decontaminated and odourless gridates/filtrates are forwarded to a tank of continuous electrolysis to be oxidised in liquid state. The liquid sewage comes to the oxidation tank where a REDOX meter is situated measuring the residual oxidants in the sewage and transmitting the readings to the PLC. A dosage pump directed by the PLC forwards oxidants till their concentration in the sewage will reach 15 to 500 mg/l. By means of a pump, the treated sewage is forwarded to an electrode supported by an electronic DC power supply 5V-60V, −1000 A, and during its passage through the electrode, is electrolysed under a voltage of 48V for further oxidation/degradation of the organic substances, the whole oxidants being subjected to an immediate neutralization by sodium sulphite when coming out of the electrode. Then, the treated sewage passes through an activated carbon filter and is discharged into the receiver.

### EXAMPLE

Nine hundred (900) litres of an aqueous sodium chloride solution, conc. 5%, are carried into a tank of an effective capacity of 1 m³, and by means of a pump (26) are recirculated through an electrode (25), being an anode, as referred to in greek patent 201004008. The electrode is supported by a DC power supply (24), volt. −60 V and int. −1000 A. The aqueous solution of NaCl is electrolysed for six hours and the following oxidants are produced: nascent chlorine, nascent ozone, hydrogen peroxide, atomic oxygen and chlorine oxide at a concentration of 1000 mg/l to 9000 mg/l. Subsequently, the oxidants are forwarded by means of a pump (28) to the oxidant storage tank (29) of an effective capacity 2 m³. From the tank (29), the oxidants are forwarded by means of a dosage pump (31), flow rate 100 l/h, and are mixed with urban sewage in the pump station (1) situated before the sewage entrance of its treatment unit. Subsequently, the sewage, oxidised by nascent chlorine, nascent ozone, hydrogen peroxide, atomic oxygen and chlorine dioxide, enters by means of the pump (2) its treatment unit and comes to the sand sedimentation tank (3). The sewage comes, from the sand sedimentation tank (3) and by means of the pump (4), to four successive self-cleansed grids (5), with openings 1.5 mm, 0.75 mm, 0.50 mm, 0.25 mm respectively flowing freely to a type DAFF defatting system (6). After DAFF the sewage passes, by means of a pump (7), through four self-cleansed filters (8) with 100μ, 75μ, 30μ, 5μ meshes.

All gridates/filtrates reach a liquid oxidation tank (18) containing an aqueous solution of NaCl 6% and through a pump (17) the gridate/filtrate and brine mixture recirculates continuously and is electrolyzed by an electrode (16) supported by a DC power supply (15), volt. −60V and int. −1000 A. In the tank (18), there are float switches of upper (32) and lower level transmitting the readings to the PLC (36), which activates the pump (19) forwarding the oxidant-treated sewage mixture into the tank (20) where an immediate neutralization of all oxidants occurs on PLC command, receiving readings from the REDOX meter. The oxidant neutralization is realized by sodium sulfite, deriving from the tank (22) by a dosage pump (21). The liquid sewage having passed through the grids, DAFF and filters with oxidants therein, comes to a tank (9) for further oxidation. Inside the tank (9), a REDOX meter takes readings that transmits to the PLC (36) which, according to the oxidant concentration of the urban sewage, actuates a dosage pump (30) and oxidants from the oxidant storage tank (29) are forwarded to the further oxidation pump (9) till attaining an oxidant reading of 150 ppm expressed as free chlorine. The tank (9) has a sufficient capacity so that the sewage will remain therein for four hours, flowing thereafter freely into a tank (10). The oxidized sewage passes by means of a pump (11) through the electrode (13) supported by a power supply (12), −60V DC and −300 A, providing an enhanced production of nascent ozone, hydrogen peroxide, oxygen roots and hydrogen to destroy any organic compounds, subjected to an immediate neutralization of all oxidants when coming out of the electrode by means of sodium sulfite entering the treated sewage flow from the tank (22) by means of the pump (23). Subsequently, the treated sewage passes through an activated carbon filter (14) and is discharged in the receiver.

1. An electrolytic process for managing urban sewage wherein the oxidative liquid that is mixed with the sewage oxidizing it in liquid phase, is produced in an electrolytic mode, consisting of the following oxidants: nascent ozone, nascent chlorine, atomic oxygen, chlorine dioxide, hydrogen peroxide, the oxidant mixing with the sewage being performed before the sewage entry into its treatment unit, the sewage-oxidant solution subjected to sand sedimentation, gridding, defatting, further oxidation, electrolysis under a high voltage exceeding 16V, reduction with sodium sulfite, the gridates along with the filtrates oxidized in a special tank of continuous electrolysis and neutralized by sodium sulfite.

2. An electrolytic process for managing urban sewage according to claim 1, wherein the oxidants are mixed with the sewage in the last pump station before sewage entering the treatment unit, the sewage concentration expressed as residual free chlorine being 5 mg/l to 200 mg/l.

3. An electrolytic process for managing urban sewage according to claim 1, wherein the sewage during the sand sedimentation phase contains oxidants expressed as residual free chlorine from 5 mg/l to 200 mg/l.

4. An electrolytic process for managing urban sewage according to claim 1, wherein the sewage contains oxidants expressed as residual free chlorine from 5 mg/l to 200 mg/l and passes through self-cleansed grids with openings from 2.5 mm to 0.25 mm.

5. An electrolytic process for managing urban sewage according to claim 1, wherein the sewage during the defatting phase with a DAFF system, contains oxidants expressed as residual free chlorine from 5 mg/l to 200 mg/l.

6. An electrolytic process for managing urban sewage according to claim 1, wherein the sewage following the sand sedimentation, gridding and defatting phases, contains oxidants expressed as residual free chlorine from 5 mg/l to 200 mg/l and passes through self-cleansed filters with meshes of 150μ to 5μ.

7. An electrolytic process for managing urban sewage according to claim 1, wherein the gridates collected from the grids and the filtrates collected from the filters come into a tank containing an aqueous solution of NaCl 2-6% and are electrolyzed under a DC voltage 6 to 60, the oxidants contained therein being neutralized by sodium sulfite after getting out of the electrolyze tank.

8. An electrolytic process for managing urban sewage according to claim 1, wherein the sewage after defatting and removal of particles above 5μ come to an oxidation tank where a REDOX meter and a pH meter give readings to a microprocessor adding oxidants from a storage tank thereof by means of a dosage pump till attaining an oxidant concentration in the sewage under treatment expressed as free chlorine from 15 mg/l to 500 mg/l.

9. An electrolytic process for managing urban sewage according to claim 1, wherein the sewage after remaining in the oxidation tank passes through the electrode under a DC voltage above 16V, being reduced by sodium sulfite when getting out of the electrode.

10. An electrolytic process for managing urban sewage according to claim 1, wherein the oxidant concentration produced by electrolysis for the sewage liquid oxidation, expressed as free chlorine, is from 1000 mg/l to 9000 mg/l.
